(19) United States
(12) Patent Application Publication
(10) Pub. No.: US 2007/0030563 A1
(43) Pub. Date: Feb. 8, 2007

(54) MULTI-BANDPASS FILTER FOR PROJECTION ARRANGEMENTS

(75) Inventor: Othmar Zueger, Triesen (LI)

Correspondence Address: PEARNE & GORDON LLP, 1801 EAST 9TH STREET, SUITE 1200, CLEVELAND, OH, 44114-3108, US

(73) Assignee: Unaxis Balzers Ltd., Balzers (LI)

(21) Appl. No.: 11/422,393

(22) Filed: Jun. 6, 2006

Related U.S. Application Data
(60) Provisional application No. 60/688,230, filed on Jun. 7, 2005.

(51) Int. Cl. F21V 9/04; G02B 5/28

(52) U.S. Cl. 359/359; 359/589

(57) ABSTRACT

An optical filter for manipulating the spectrum of a light source is comprised of a transparent substrate and a first layer system applied to only one side, preferably an interference layer system. The substrate and the first layer system form a combined UV and IR filter (UV-IR filter) such that radiation portions both below a wavelength of 420 nm, particularly in the UV range, and above a wavelength of 690 nm, particularly in the IR range, are not fully transmitted via the first layer system.

The invention relates to a multi-bandpass filter for use in color projection devices for efficient color correction.

### BACKGROUND OF THE INVENTION

So far it has not been possible to replace the gas discharge lamps used today as white light sources in color projection systems in terms of intensity and reliability. Yet, they have a series of undesirable radiation characteristics, which require action.

Gas discharge lamps like those used in projection displays, in addition to visible light, also emit high-intensity ultraviolet (UV) radiation and infrared (IR) radiation. In this specification, UV radiation is considered radiation with a wavelength less than 420 nm, but greater than 300 nm. IR radiation is radiation with a wavelength greater than 690 nm, but less than 2 μm. These UV and IR rays can cause significant damage to the optical components of typical projection display devices. When subjected to UV radiation, the component materials may decompose. This happens particularly to components containing organic materials. The IR rays may result in extraordinarily high and hence stressful temperatures and/or temperature gradients inside the optical components and, in extreme cases, may destroy them.

For this reason, both UV filters and IR filters are required in projection display applications. Filters of this kind are particularly necessary for projectors, which use liquid crystal components (LCD) as imaging elements. LCDs of this type are particularly sensitive to UV radiation and/or high temperatures.

The UV and IR filters are generally placed directly behind the light source in the optical path in order to filter out damaging UV and IR components of the radiation as early as possible.

In configurations based on 3 imaging elements, the light, which is generally white, is split into three beam paths. Typically such splitting is done using two dichroic color filters, which are placed, for example, at a 45° angle on the optical axis in the beam path. If the first filter is a blue reflector, for example, blue light B is reflected at an angle of 45°, i.e. deflected 90°, while green light G and red light R are transmitted through the filter. If the second filter is a green reflector, green light G is reflected and red light R is transmitted. This way the original beam of white light is split into three partial beams.

However, splitting it cleanly at wavelength intervals is difficult because generally the dichroic filters are not acted on by parallel beams of light, but instead a wide range of angles is represented in most cases. The reason for this is that lenses are installed in the projector in an attempt to minimize loss along the path of the beam. The consequences are non-parallel light beams, so-called conical intensity distributions with low F-numbers. Since the spectral characteristics of dichroic filters vary as a function of the angle of incidence (particularly in relation to the position of the filter edges), spectral splitting is limited, and the color of the beams inside the cone of incidence varies as a function of the angle of incidence.

This means that the blue light beam may have portions of its wavelength that may actually be associated with the green light beam, the green light beam also has blue and yellow-red portions, and the red light beam also has yellow components. These undesirable components make the color saturation that can be achieved with the projection device insufficient in many cases.

If UHP lamps are used, there are also pronounced interfering intensity peaks present in the emission spectrum. In particular, the intensive yellow peak produces a slightly red impression in the image.

It is therefore necessary to improve the color saturation. Typically, color filters are used for this purpose, i.e. so-called trim filters are placed in the individual partial beams. These trim filters are normally also composed of dichroic filters, but they are placed perpendicularly or almost perpendicularly in the path of the individual partial beams R, G and B. Since the angular dependence of the spectral characteristics of these dichroic filters is less prominent for small angles (with almost perpendicular incidence), the color saturation improves significantly.

However, one disadvantage is that the additional trim filters result in added cost. To produce these filters, additional substrates have to be vacuum-coated. These filters must also be placed in the housing, which requires other holders and/or assembly and adjustment steps. In addition, although the trim filters are used at a basically perpendicular angle of incidence, due to the cone of light and the angular distribution produced in it, a relatively broad spectrum of angles is produced. As a result, the color saturation cannot yet be optimally configured.

### THE OBJECT OF THIS INVENTION

The object of this invention is therefore to solve, at least partially, the aforementioned problems in the state of the art. In particular, the object of this invention is to achieve good color saturation with no need for additional components, such as trim filters, in the paths of the partial beams.

### THE SOLUTION IN THE INVENTION

The invention solves the problem by manipulating the spectrum by means of a modified UV-IR filter placed basically directly behind the lamp.

Typically, UV filters and IR filters are made on two substrates or on the two opposite sides of a transparent substrate.

In the first embodiment of this invention, the UV filter and the IR filter are built into a system of layers that is made on only one side of the substrate. On the opposite side of it, for example, a simple anti-reflective coating can then be provided.

In another embodiment of this invention, in the area where otherwise only UV radiation and IR radiation are blocked, now the crossover areas between blue and green and between green and red are blocked, at least partially, and so color trimming is already achieved shortly after the beams are produced. This can be done with an additional filter in front of the UV-IR filter or behind it. However, it is a special advantage, and therefore also an inventive step, to build a trim filter of this type directly into the system of layers of the UV-IR filter. This obviates the need for one or more additional substrates, which otherwise would be required for the trim filter.

### DETAILED DESCRIPTION OF THE INVENTION

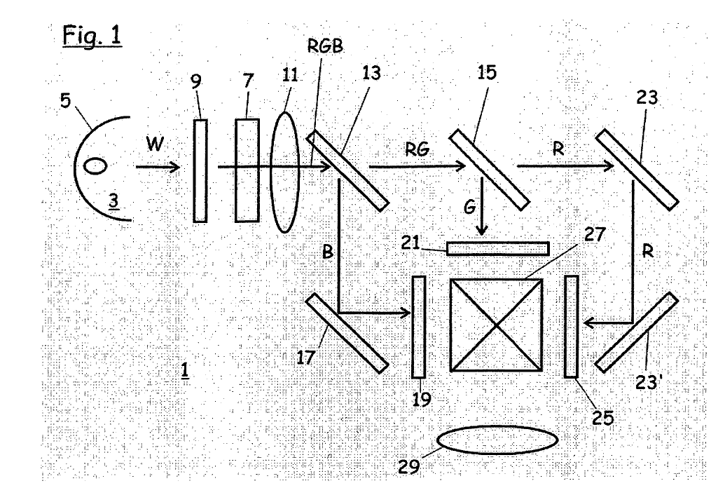

FIG. 1 The projection arrangement in the invention

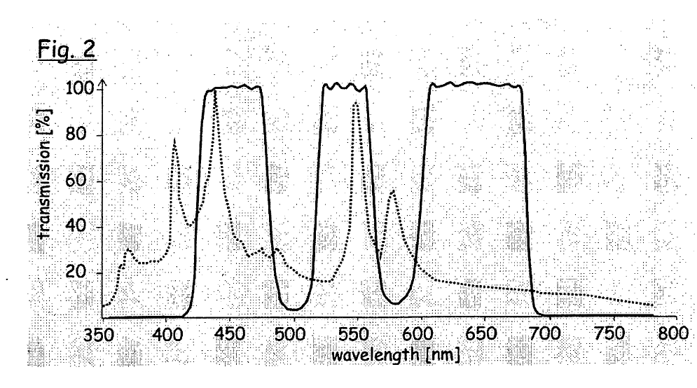

FIG. 2 The spectral characteristics of the multi-bandpass filter in the invention

This invention will be explained in greater detail below with reference to the examples given in the figures.

FIG. 1 is a schematic view of one possible configuration 1 in this invention. The light source 3 emits lamp-specific white unpolarized light W. The reflector 5 in this example is a parabolic reflector, so that a basically parallel beam of light leaves the lamp. A parallel beam of light like this is typically used when the effective action of a downstream polarization conversion element (PCA) 7 is desired. According to the invention, a spectral multi-bandpass filter 9 is placed between the PCA and the reflector, and the filter's spectral characteristics are shown schematically in FIG. 2 by a solid line. It is clear that the multi-bandpass filter has a blocking effect not only for the UV range (below 420 nm) and the IR range (above 690 nm), but also considerably weakens transmission and effectively suppresses it for the crossover area from the blue wavelength range to the green wavelength range (490 nm-510 nm) and for the crossover area from the green wavelength range to the red wavelength range (570 nm-590 nm). The dotted line in FIG. 2 represents the spectrum of a UHP lamp. It is clear that the intensity peak of the lamp spectrum found, for example, at 580 nm can be weakened considerably by the filter, which is certainly desirable. Due to the relatively good parallelism of the light beams reflected by the parabolic reflector, basically perpendicular incident light is supplied to the multi-bandpass filter 9. As a result, the spectral characteristics of the multi-bandpass filter 9 are not distorted by varying angles of incidence. This inventive arrangement thus allows a very high degree of color saturation.

This means that modified white light, which contains at least roughly three separate wavelength ranges RGB and to a large extent no longer contains any UV and IR components, is transmitted by the multi-bandpass filter. In the drawing, this light has been marked as RGB light.

The PCA 7 and, if need be, a first lens system 11 are now downstream from the multi-bandpass filter 9. Further downstream in this example is a first dichroic mirror 13, which reflects blue light B and transmits red light R and green light G. Further downstream from the red and green partial beams, there is a second dichroic mirror 15. It reflects green light G, while it basically transmits red light R. As a result, the original unpolarized beam of white light is split into three colored, basically polarized partial beams.

The reflected blue light B is reflected via a deflecting mirror 17 in the direction of the transmissive liquid crystal component tLCD blue 19 provided for blue light. There, its polarization is modulated spectrally resolved. Typically, in the state of the art, a trim filter would be placed upstream from the tLCD. But because of the multi-bandpass filter 9 in the invention, this is not necessary. A polarization filter connected downstream from the tLCD transforms the spectrally resolved, polarization modulation into spectrally resolved, intensity modulation.

The green light G accordingly shines on a tLCD green 21 and is polarization-modulated there. The polarization modulation is transformed to intensity modulation by means of a polarization filter (not shown).

The transmitted red light R is reflected via deflecting mirrors 23, 23′ in the direction of the transmissive liquid crystal component tLCD red 25 provided for the red light. There, its polarization is modulated spectrally resolved. A polarization filter connected downstream transforms the spectrally resolved polarization modulation into spectrally resolved intensity modulation.

In the example, the spatially intensity-modulated partial beams are combined downstream by means of a color cube 27.

The color cube is followed by a projection lens system 29, which contains at least one lens and reproduces the image defined by spatial modulation of the tLCDs on a projection plane.

In the state of the art, trim filters would be connected directly in front of the tLCDs. The inventive multi-bandpass filter provided in this invention directly behind the light source, however, eliminates the need for this. In essence, the trim filter can be eliminated.

For further fine trimming, however, it is certainly conceivable to provide additional trim filters without running counter to the purpose of the invention.

As FIG. 2 shows, in one embodiment of this invention, the layer system combined with the substrate forms a multi-bandpass filter, which is not only a UV-IR filter, but also blocks transmission at least partially in the crossover areas between blue and green at 490 to 510 nm as well as between green and red at 570-590 nm.

The transmission difference between 415 nm and 435 nm is preferably at least 90%, and/or the transmission difference between 675 nm and 700 nm is preferably at least 90%.

The transmission in the crossover areas between blue and green and between green and red is preferably at least less than 10%.

The system of layers used to configure the UV-IR filter preferably contains an interference layer system. By varying the refractive index of the layers in the system, interference effects of the light occur inside the layer system, resulting in wavelength-dependent reflection and/or transmission. Interference layer systems may contain an alternating system of layers made of materials with a high refractive index and a low refractive index. Materials with an index more than 1.70 at a wavelength of 550 nm are considered materials with a high refractive index. Examples are TiO₂ and Ta₂O₅. Materials with a refractive index less than 1.55 at a wavelength of 550 nm are considered materials with a low refractive index. Examples are SiO₂ and MgF₂. Materials with a refractive index greater than or equal to 1.55 and less than or equal to 1.70 at a wavelength of 550 nm are considered materials with an average refractive index. An example is Al₂O₃. Optical interference layer systems suitable for this invention may contain materials from only one of these three groups, only two of these three groups or all three groups or mixtures thereof. Preferably, however, an optical interference layer system is made of a system of alternating layers of materials from the groups of materials with high and low refractive indices.

### LIST OF REFERENCE NUMBERS

1 Projector
3 Light Source
5 Reflector
7 Polarization Conversion Element
9 Multi-bandpass filter
11 Lens System
13 First Dichroic Mirror
15 Second Dichroic Mirror
17 Deflecting Mirror
19 tLCD blue
21 tLCD green
23 Deflecting Mirror
25 tLCD red
27 Color Cube
W White Lamp-Specific Light
B Blue light, typically with a wavelength of 420 nm to 490 nm in air
G Green light, typically with a wavelength of 510 nm to 570 nm in air
R Red light, typically with a wavelength of 590 nm to 690 nm in air
RBG Modified light with R, B and G components

1 An optical filter for manipulating the spectrum of a light source, whereby the optical filter is comprised of a transparent substrate and a first layer system applied to only one side, preferably an interference layer system, characterized in that the substrate and the first layer system form a combined UV and IR filter (UV-IR filter) such that radiation portions both below a wavelength of 420 nm, particularly in the UV range, and above a wavelength of 690 nm, particularly in the IR range, are not fully transmitted by the first layer system.

2 The UV-IR filter in claim 1, characterized in that an anti-reflective coating is applied to the side that does not have the first layer system.

3 The UV-IR filter in claims 1 to 2, characterized in that the first layer system combined with the substrate also at least partially blocks the transmission in the crossover areas between blue and green at 490 to 510 nm, and between green and red at 570-590 nm.

4 The UV-IR filter in claim 3, characterized in that the transmission difference between 415 nm and 435 nm amounts to at least 90%.

5 The UV-IR filter in claims 3 and/or 4, characterized in that the transmission difference between 675 nm and 700 nm amounts to at least 90%.

6 The UV-IR filter in claims 3 to 5, characterized in that the transmission is at the minimum less than 10% in the crossover areas between blue and green and between green and red.

7 A projection arrangement comprising at least one light source (3) for emitting a light beam, means (5) of collimating the light beam, dichroic mirrors (13, 15) for splitting the light beam into three partial beams (R, B, G), basically composed of blue, green and red partial spectra, transmissive LCD elements (19, 21, 25) for modulating the partial beams (R, B, G), means (27) of combining the partial beams, and a projection lens system (29) for showing the combined, modulated partial beams on a projection plane, characterized in that the projection arrangement is also comprised of a UV-IR filter according to claims 1-6.

8 A projection system according to claim 7, characterized in that no other filters are used to correct the spectrum in the path between the light source (3) and the projection lens system (29).

9 A projection system according to claim 7, characterized in that a maximum of one other filter is used to correct the spectrum in the path between the light source (3) and the projection lens system (29).
